(19) United States
(12) Patent Application Publication
(10) Pub. No.: US 2016/0237790 A1
(43) Pub. Date: Aug. 18, 2016

(54) BULK CAPACITOR CHARGING CIRCUIT FOR MUD PULSE TELEMETRY DEVICE

(71) Applicant: Halliburton Energy Services, Inc., Houston, TX (US)

(72) Inventor: Percival F. Williams, Cheltenham (GB)

(21) Appl. No.: 14/429,723

(22) PCT Filed: Nov. 5, 2013
(86) PCT No.: PCT/US2013/068467

§ 371 Date: Mar. 19, 2015

(51) Int. Cl. E21B 41/00; H02J 7/00; E21B 47/18

(52) U.S. Cl. CPC E21B 41/0085; E21B 47/18; H02J 7/0052; H02J 7/0029; H02J 7/345

(57) ABSTRACT

A method and apparatus for charging a bulk energy storage capacitor, such as used for actuating solenoids in downhole tools. An electrical generator, which may be a mud-powered, provides a rectified voltage proportional to its rotational speed. The rectified voltage is fed to a single-ended primary-inductor converter, which in turn charges the bulk capacitor 16 when the voltage across the bulk capacitor falls between predetermined upper and lower set points. Upon discharging the bulk capacitor, such as from actuation of solenoid valves for creating mud pressure pulses, control logic also causes the converter to cease charging the bulk capacitor 16 to enhance circuit efficiency and performance. A battery may also be provided to charge the bulk capacitor via a current limiter, and a disconnect circuit prevents the battery from charging the bulk capacitor when the generator is charging the bulk capacitor via the converter.

### TECHNICAL FIELD

The present disclosure relates generally to oilfield equipment, and in particular to downhole tools.

### BACKGROUND

Various downhole tools use mud pulse telemetry to transmit information during drilling operations. One known method uses a mud pulse generator to create negative pressure pulses in the borehole. A solenoid is used to open and shut a valve in a system that generates pressure pulses into a drilling mud. The pulses correspond to a Manchester or other encoding system to enable signals to be transmitted from the bottom of the borehole to the surface.

Existing arrangements typically drive the solenoid valve from a high capacitance bulk capacitor, for instance 7600 μg, which stores the required electrical energy and provides a high current discharge capability for rapidly actuating the solenoid. The bulk capacitor is charged more slowly than it is discharged, using a lower current rated DC fixed voltage power supply between the instances of solenoid actuation.

For instance, the bulk capacitor may be charged by one or more batteries, such as a series of 90V batteries, through a linear current limiter circuit. The purpose of the current limiter is to prevent damage to the batteries by excessive current during capacitor charging. However, linear current limiters are inefficient. For example, while charging the bulk capacitor from 60V to 90V at 700 mA, the average power lost per charging cycle is 10.5 watts.

Alternatively, an electrical generator powered by mud flow may be used to charge the bulk capacitor. Because the generator output voltage is proportional to mud flow, which is variable, a regulated DC power supply circuit is used downstream of the generator to charge the bulk capacitor. Regulated power supplies tend to be large, add complexity, and have a limited input voltage range and operating temperature limit. Accordingly, it is desirable to provide a DC power supply circuit that fits within the limited available space of the downhole tool, extends the range of generator operation, and operates at higher temperatures.

Additionally, it is desirable to provide a DC power supply circuit that allows both charging of the bulk capacitor from either a battery or a mud-powered electrical generator.

### BRIEF DESCRIPTION OF THE DRAWINGS

Embodiments are described in detail hereinafter with reference to the accompanying figures, in which:

FIG. 1 is a block-level schematic diagram of a measurement while drilling system according to a preferred embodiment, showing a drill string and a drill bit for drilling a bore in the earth and a mud pulse telemetry tool disposed in a drill string incorporating the bulk capacitor charging circuit of FIG. 2;

FIG. 2 is a simplified block level schematic diagram of a bulk capacitor charging circuit according to a preferred embodiment, showing a generator for charging the capacitor via a converter;

FIG. 3 is a detailed schematic diagram of the bulk capacitor charging circuit of FIG. 2, showing details of modified a single-ended primary-inductance converter;

FIG. 4 is a flow chart diagram showing logic implemented by the bulk capacitor charging circuit of FIG. 3;

FIG. 5 is a simplified block level schematic diagram of the bulk capacitor charging circuit of FIG. 2 augmented by a battery and battery control circuit to allow charging the bulk capacitor either from the converter or from a battery;

FIG. 6 is a detailed schematic diagram of the bulk capacitor charging circuit of FIG. 5 according to an embodiment; and

FIG. 7 is a flow chart diagram showing battery-connection logic implemented by the bulk capacitor charging circuit of FIG. 6.

### DETAILED DESCRIPTION

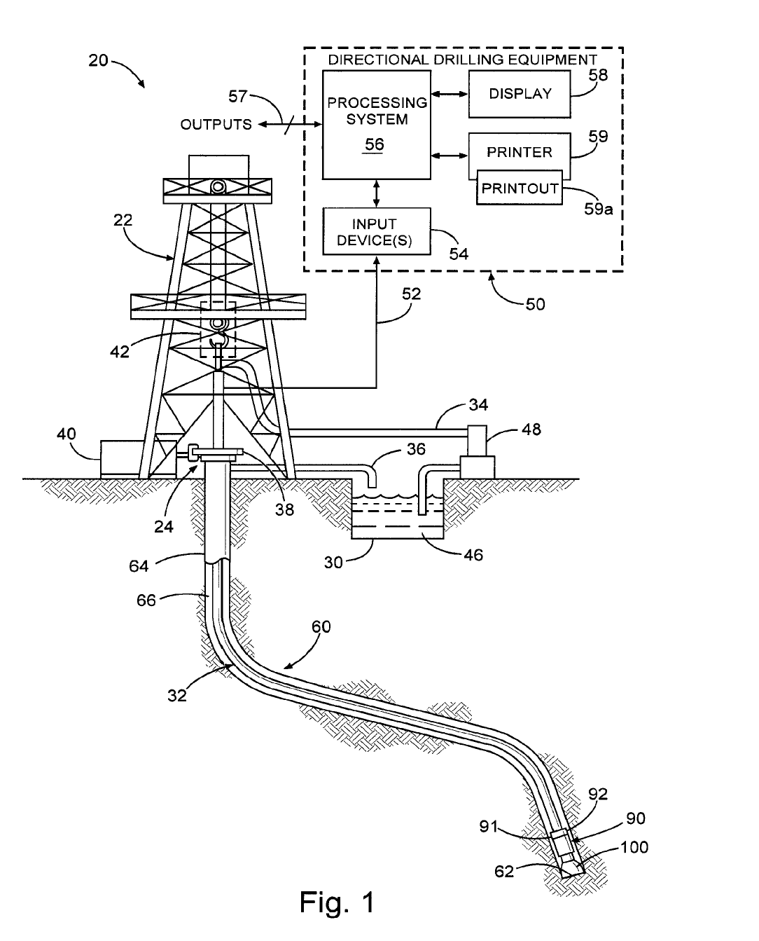

Attention is directed to FIG. 1, which shows a measurement while drilling (MWD) or logging while drilling (LWD) system of the present disclosure. As a generalization, the system shown in FIG. 1 is generally identified by the numeral 20.

MWD system 20 may include land drilling rig 22. However, teachings of the present disclosure may be satisfactorily used in association with offshore platforms, semi-submersible, drill ships and any other drilling system satisfactory for forming a wellbore extending through one or more downhole formations.

Drilling rig 22 and associated directional drilling equipment 50 may be located proximate well head 24. Drilling rig 22 also includes rotary table 38, rotary drive motor 40 and other equipment associated with rotation of drill string 32 within wellbore 60. Annulus 66 may be formed between the exterior of drill string 32 and the inside diameter of wellbore 60.

For some applications drilling rig 22 may also include top drive motor or top drive unit 42. Blow out preventers (not expressly shown) and other equipment associated with drilling a wellbore may also be provided at well head 24. One or more pumps 48 may be used to pump drilling fluid 46 from fluid reservoir or pit 30 to one end of drill string 32 extending from well head 24. Conduit 34 may be used to supply drilling fluid from pump 48 to the one end of drilling string 32 extending from well head 24. Conduit 36 may be used to return drilling fluid, reservoir fluids, formation cuttings and/or downhole debris from the bottom or end 62 of wellbore 60 to fluid reservoir or pit 30. Various types of pipes, tube and/or conduits may be used to form conduits 34 and 36.

Drill string 32 may extend from well head 24 and may be coupled with a supply of drilling fluid, such as pit or reservoir 30. The opposite end of drill string 32 may include bottom hole assembly 90 having a rotary drill bit 100 disposed adjacent to end 62 of wellbore 60. Bottom hole assembly 90 may also include bit subs, mud motors, stabilizers, drill collars, or similar equipment, as known in the art. Rotary drill bit 100 may include one or more fluid flow passageways with respective nozzles disposed therein. Various types of drilling fluids 46 may be pumped from reservoir 30 through pump 48 and conduit 34 to the end of drill string 32 extending from well head 24. The drilling fluid 46 may flow through a longitudinal bore (not expressly shown) of drill string 32 and exit from nozzles formed in rotary drill bit 100.

At end 62 of wellbore 60 drilling fluid 46 may mix with formation cuttings and other downhole fluids and debris proximate drill bit 100. The drilling fluid will then flow upwardly through annulus 66 to return formation cuttings and other downhole debris to well head 24. Conduit 36 may return the drilling fluid to reservoir 30. Various types of screens, filters and/or centrifuges (not expressly shown) may be provided to remove formation cuttings and other downhole debris prior to returning drilling fluid to pit 30.

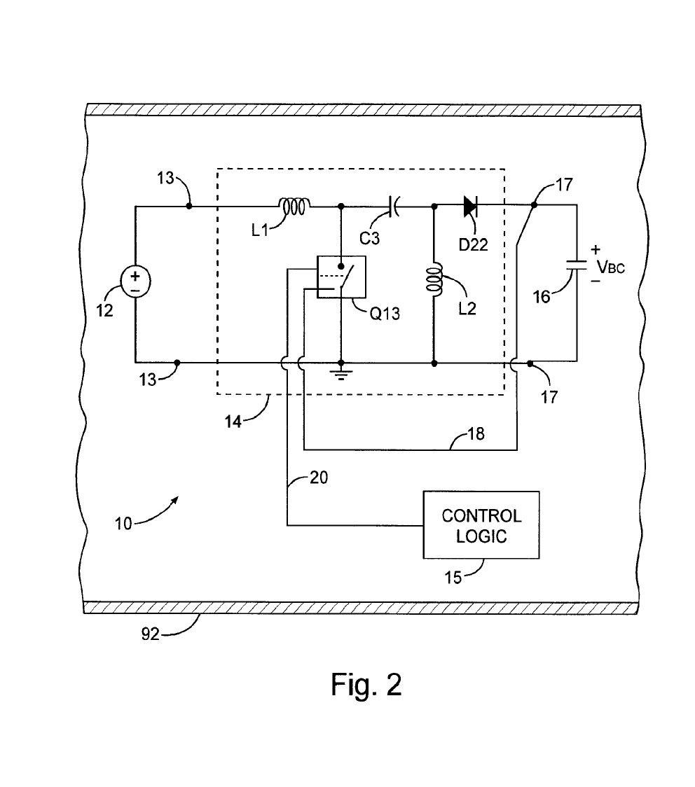

Bottom hole assembly 90 may also include various tools 91 that provide logging or measurement data and other information about wellbore 60. This data and information may be monitored by a control system 50. In particular, bottom hole assembly 90 includes a downhole tool 91 having a telemetry device including a bulk capacitor charging circuit 10 or 10′ as described below with respect to FIGS. 2-4. However other various types of tools may be included in bottom hole assembly 90 as appropriate.

Measurement data and other information may be communicated from end 62 of wellbore 60 through fluid within drill string 32 or the annulus using MWD techniques and converted to electrical signals at well surface 24. Electrical conduit or wires 52 may communicate the electrical signals to input device 54. The measurement data provided from input device 54 may then be directed to a data processing system 56. Various displays 58 may be provided as part of control system 50.

For some applications printer 59 and associated printouts 59 a may also be used to monitor the performance of drilling string 32, bottom hole assembly 90 and associated rotary drill bit 100. Outputs 57 may be communicated to various components associated with operating drilling rig 22 and may also be communicated to various remote locations to monitor the performance of drilling system 20.

FIG. 2 is a simplified schematic diagram of the bulk capacitor charging circuit 10 according to a preferred embodiment that illustrates its principle of operation. A downhole electrical generator 12 provides a rectified voltage proportional to its rotational speed. Electrical generator 12 is preferably powered by flow of drilling fluid, which may be provided to generator 12 via drill string 32 (FIG. 1). In some embodiments, the useful range of voltage of generator 12 is approximately 100 volts to 400 volts. The rectified voltage is fed to a converter 14, which in turn charges the bulk capacitor 16. That is, converter 14 selectively transfers charge from generator 12 to bulk capacitor 16 as further described below. Bulk capacitor 16 may be a large capacitor that is specified for storing energy to be used in operating an actuator (not illustrated) of downhole tool 91. In an embodiment, downhole tool 91 may include a telemetry device, and the actuator may be the solenoid of a solenoid-operated valve for producing a pressure pulse in the drilling fluid, for example. Although bulk capacitor 16 is discussed herein as a single capacitor, one of ordinary skill in the art understands that bulk capacitor 16 may include multiple discrete capacitors connected together in series, parallel, or a combination thereof.

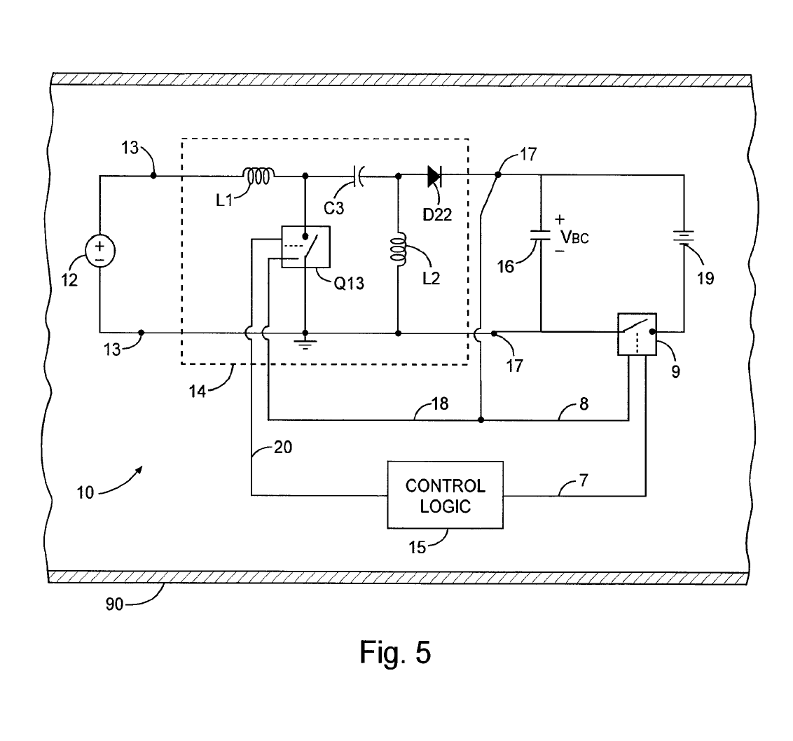

Converter 14 may be located in a downhole tool 91 (FIG. 1), which has a housing 92 that protects the electronic components from the hazards of the downhole environment. Generator 12 and/or bulk capacitor 16 may also be located in housing 92 with converter 14, as shown in FIG. 2. Alternatively, converter 14, generator 12, and bulk capacitor 16 may be located in one or more downhole components within bottom hole assembly 90, for example, as shown in FIG. 5.

Converter 14 defines a two port network, characterized by a pair of input terminals 13 and a pair of output terminals 17. Generator 12 is connected to input terminals 13 and provides a rectified DC voltage that is proportional to its rotational speed. One of the input terminals 13 is electrically connected to one of the output terminals 17 and may form a ground or common potential reference point. Bulk capacitor 16 is connected to output terminals 17.

When the voltage V_{BC} across the bulk capacitor 16 reaches a predetermined charged level, preferably about 90 volts, a voltage feedback path 18 causes converter 14 to cease charging the capacitor. Upon actuation of the actuator (not illustrated), for example, one or more solenoid-operated valves (not illustrated) for creating mud pressure pulses, control logic 15, via a control line 20, also causes converter 14 to cease charging bulk capacitor 16 to enhance circuit efficiency and performance. Under normal operating conditions, at the end of the actuation sequence, bulk capacitor 16 will have discharged from about 90 volts to 60 volts. If the capacitor voltage V_{BC} drops below a predetermined low level in the idle state, i.e., when the solenoids are not being actuated, voltage feedback path 18 causes converter 14 to recommence charging capacitor 16 to provide a top-up charge.

In a preferred embodiment, converter 14 is a single-ended primary-inductance converter (“SEPIC”), which includes inductors L1, L2, capacitor C3, diode D22, and control switching element Q13, which cycles on and off to transfer charge. In this embodiment, because converter 14 is a SEPIC, it is capable of having an output voltage that is greater than, equal to, or less than its input voltage, depending on the duty cycle of the control switching element Q13. Inductors L1 and L2 may be discrete uncoupled components, or they may be wound on the same core so as to be coupled. Coupling inductors L1 and L2 enables the inductance values to be halved and thus saves space.

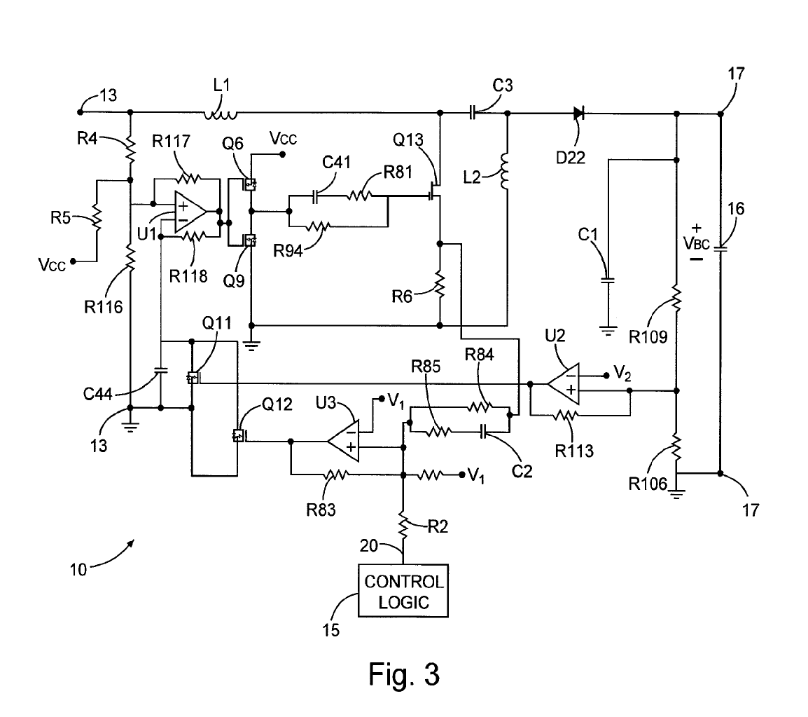

FIG. 3 is a more detailed schematic diagram of the bulk capacitor charging circuit 10 of FIG. 2. In an embodiment, control switching element Q13 may be a metal oxide semiconductor field effect transistor, bipolar transistor, insulated gate bipolar transistor, junction field effect transistor, or other suitable device.

The duty cycle of the control switching element Q13 may be determined by an oscillator, which may be connected to control switching element Q13 via a driving circuit. In one embodiment, the oscillator is a Schmitt Trigger oscillator formed of a comparator U1, resistors R117, R118, and R5, and a capacitor C44. As Schmitt Trigger oscillators are known to routineers in the art, further details are not provided herein. However, the disclosure is not limited to a particular timing device and other oscillators clocks, or crystals, for example, may be used as appropriate. Switching elements Q6 and Q9 form the driving circuit that connect the oscillator to control switching element Q13 via a capacitor C41 and resistors R81, R94. Discrete or integrated components, or a commercial driver package, may be used as appropriate, and the driver configuration may be varied as necessary to support the type of device used for control switching element Q13.

One of the advantages of a SEPIC over a conventional regulated power supply circuit is that a snubber circuit is not required to protect the system from voltage transients, because the output filter capacitor itself acts as a snubber. Not having a snubber means that the circuit runs more efficiently. However, the equivalent series resistance of bulk capacitor 16 together with the inductance of the connecting wires may prevent effective snubbing. Accordingly, capacitor C1 may be added to enhance snubbing. Capacitor C1 does not make circuit 10 less efficient, as its charge is added to the charge of the bulk capacitor 16.

Resistors R4, R5 and R116 and a voltage source V_{CC} are used to provide feed-forward from generator 12 (FIG. 2). The feed-forward varies both the frequency of oscillation and the duty-cycle in a manner that has the effect of keeping the peak current in the control switching element Q13 almost constant. The feed-forward function requires that the switching element driver circuitry inverts the output of the oscillator, as it does in circuit 10 of FIG. 3.

Switching elements Q11 and Q12 are connected so as to effectively form a logical OR-gate. If the voltage on the gate of either switching element Q11, Q12 is high, then capacitor C44 is shorted and the oscillator stops running, as described below.

In an embodiment, circuit 10 may include a converter-enabling circuit coupled between bulk capacitor 16 and the oscillator that is used to stop the oscillator from running when bulk capacitor 16 has charged up to a higher set point, its predetermined fully charged level, as follows: A voltage divider network of resistors R109 and R106 sense the voltage V_{BC} across bulk capacitor 16. The divided voltage is compared with a reference voltage V₂ applied to the inverting input of a comparator U2. When the divided voltage exceeds reference voltage V₂, comparator U2 outputs a logic high, which turns on switching element Q11, which in turn shorts the inverting input of comparator U1 to ground, thereby stopping oscillation. Resistor R113 forms a positive feedback path that provides hysteresis to ensure that when the voltage across the capacitor bank has dropped below a certain lower set point, for example due to natural leakage, the oscillator starts back up again to maintain the required voltage V_{BC} across the capacitor.

In an embodiment, circuit 10 may include a converter-disabling circuit coupled to the oscillator that shuts down the oscillator when bulk capacitor 16 is required to discharge through the solenoids for valve actuation, as follows: A control signal 20 from appropriate control logic 15 is connected to the non-inverting input of a comparator U3 via a resistor R2. A reference voltage V₁ provides a predetermined set point for the comparator U3 at its inverting input. When control signal 20 is high, comparator U3 outputs a logic high, which turns on switching element Q12, which in turn shorts the inverting input of comparator U1 to ground, thereby stopping the oscillator from running and control switching element Q13 from cycling. This optional function results in a more efficient operation of circuit 10.

Switching element Q12 also shuts down the oscillator if the drain current through control switching element Q13 is excessive. This drain current is sensed by resistor R6 and fed to the comparator U3 via resistors R84, R85 and capacitor C2. Reference voltage V₁ provides a predetermined set point for the comparator U3. Resistor R83 provides hysteresis.

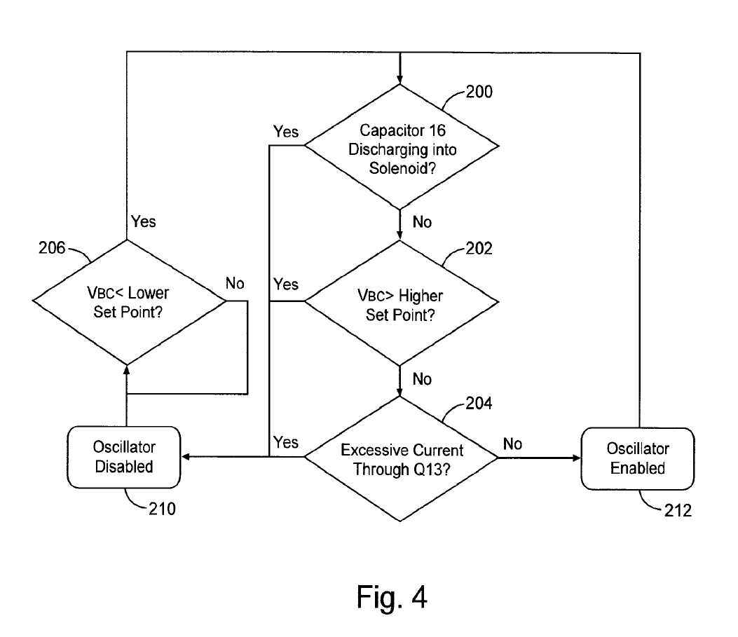

FIG. 4 represents the operation of the bulk capacitor charging circuit 10 of FIG. 3.

Referring to FIGS. 3 and 4, decision block 200, which assesses whether the bulk capacitor 16 is actively discharging into the solenoid, is implemented by control logic 15, comparator U3 and its associated circuitry, and switching element Q12. Decision block 202 assesses whether the bulk capacitor 16 is fully charged, and it is implemented by the voltage divider resistors R109, R106, comparator U2, feedback resistor R113, and switching element Q11.

Decision block 204 assesses whether the current flowing through the drain terminal of control switching element Q13 is too high, and it is implemented by resistor R6, comparator U3 and its associated circuitry, and switching element Q12.

If any one or more of the conditions of decisions blocks 200, 202, 204 exists, i.e., if the bulk capacitor 16 is actively discharging, if the bulk capacitor 16 is fully charged, or if there is excessive drain current through control switching element Q13, then the oscillator is disabled, as shown in state block 210. Otherwise, the oscillator is enabled as shown in state block 212.

If the oscillator is disabled, it will remain in the disabled state 210 so long as the voltage V_{BC} across bulk capacitor 16 remains above the lower set point, which is determined by the value of the hysteresis resistor R113 as described above. Such logic is depicted in FIG. 4 by decision block 206.

FIG. 5 is a block level schematic diagram of a bulk capacitor charging circuit 10′. Circuit 10′ of FIG. 5 is essentially the same as circuit 10 of FIG. 2, except it is augmented to allow charging of the bulk capacitor 16 from either generator 12 connected at input terminals 13 or from a battery 19 connected at output terminals 17 via a battery control circuit 9. Although discussed in terms of a singular battery 19, one skilled in the art understands that battery 19 may consists of series or parallel combinations of several discrete battery cells.

Under battery operation, electric charge is transferred from battery 19 into bulk capacitor 16 via battery control circuit 9. In an embodiment, battery control circuit 9 may perform one or more of the following functions: Connecting battery 19 to bulk capacitor 16 when a battery-supply mode of operation is desired by the operator; limiting current flow through battery 19 while charging bulk capacitor 16 using the battery; disconnecting battery 19 during the time that bulk capacitor 16 is being discharged into the actuator; and preventing the charging of bulk capacitor 16 by battery 19 when generator 12 is operating by disconnecting battery 19 from bulk capacitor 16.

Battery control circuit 9 may include a battery-enabling switching element that is coupled by a control line 7 to control logic 15, which when in a first state serves to connect battery 19 to bulk capacitor 16 when a battery-supply mode of operation is desired by the operator and when in a second state to disconnect battery 19 during the time that bulk capacitor 16 is being discharged into the actuator. Battery control circuit 9 may also include a battery-disabling circuit that is coupled by a signal path 8 to output terminal 17 so as to sense when generator 12 is charging bulk capacitor 16 and automatically disconnect battery 19 from bulk capacitor 16 during such periods.

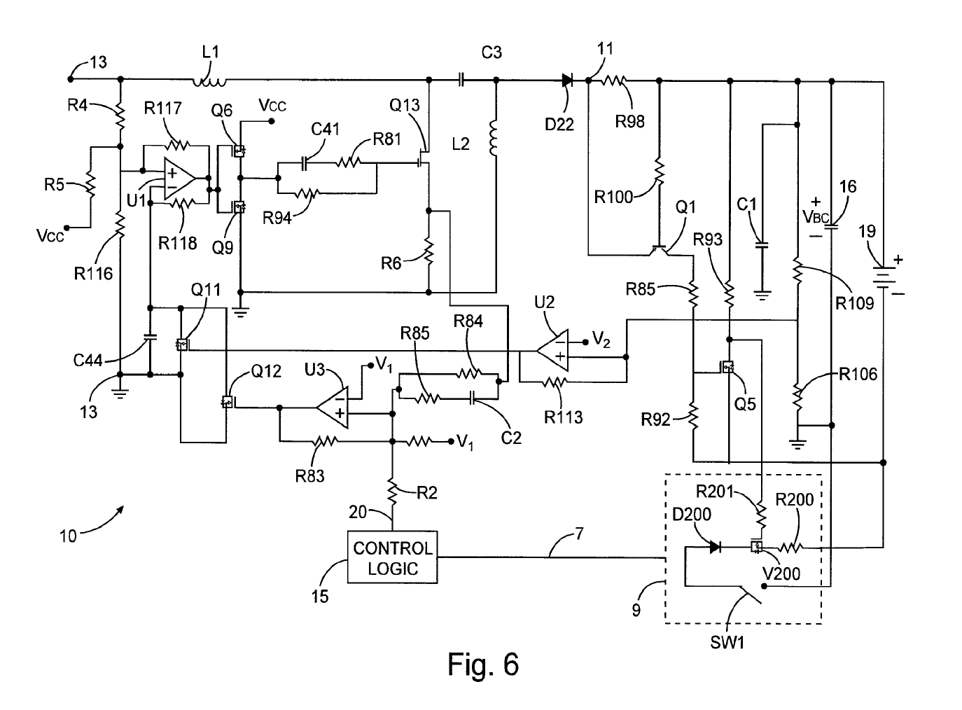

FIG. 6 is a detailed schematic diagram of bulk capacitor charging circuit 10′ of FIG. 5. Many of the circuit elements and functions are essentially the same as circuit 10 of FIG. 3 and to avoid repetition are not discussed again.

In an embodiment, battery control circuit 9 may have a current limiter including diode D200, transistor Q200 and resistor 8200. The current limiting transistor Q200 is turned on by biasing at its gate from the positive terminal of battery 19 through resistors R93 and R201. Although the current limiter described herein is a linear current limiter, a switch mode current limiter may also be used as appropriate.

In an embodiment, signal path 8 (FIG. 5) and a portion of battery control circuit 9 define a battery-disabling circuit that implements the function of preventing the charging of bulk capacitor 16 by battery 19 when generator 12 (FIG. 5) is operating as follows: Current through node 11 charges bulk capacitor 16 via resistor R98, a low Ohmic value resistor.

Some of the output current flows through a parallel path—into the emitter of switching element Q1 and out of its base via resistor R100—thereby turning on switching element Q1. Switching element Q1 then turns on switching element Q5 by applying voltage to its gate via the voltage divider network consisting of resistors R85 and R92. Switching element Q5 in turn prevents current flow through the current limiter transistor Q200 by shorting the gate-source potential at transistor Q200 to zero, thereby ensuring that bulk capacitor 16 is charged up solely by the generator and not by battery 30. In this sense, current limiter transistor Q200 also acts as an “on-off” switching element.

Battery control circuit 9 may also have a battery-enabling switching element SW1. Under battery operation, current flows from the positive terminal of battery 19 into bulk capacitor 16, through battery-enabling switching element SW1, the current limiter circuit described above, and back to the negative terminal of battery 30. Switch SW1 disconnects battery 19 during the time that the capacitor bank is being discharged into the solenoids. Battery-enabling switching element SW1 may be controlled by control logic 15, manually, or by other suitable arrangement. Alternatively, the function implemented by battery-enabling switching element SW1 may instead be implemented by the current limiter transistor Q200 by using control logic 15 to selectively short the gate-source potential at transistor Q200 to zero.

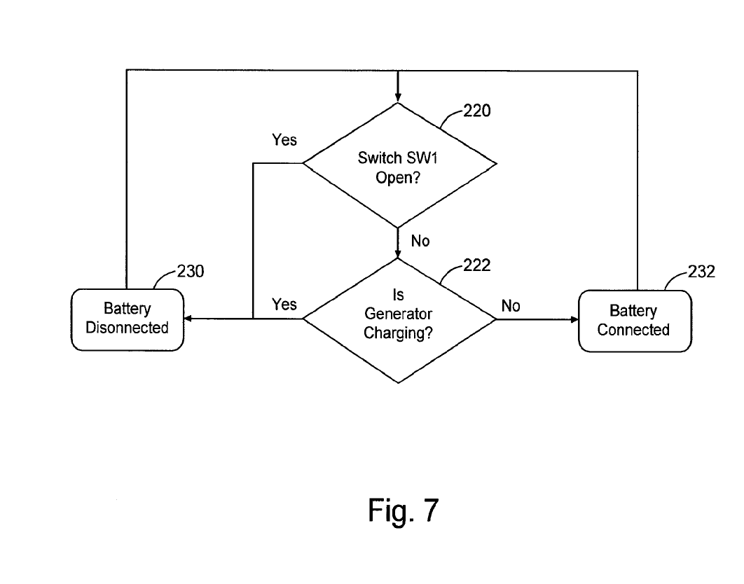

FIG. 7 represents the operation of the battery-connection circuitry of FIG. 6. Referring to FIGS. 6 and 7, decision block 220 assesses whether battery-enabling switching element

SW1 is open or closed, and decision block 222 assesses whether converter 14 is charging bulk capacitor 16, i.e., whether the generator 12 (FIG. 4) is operating. In the specific embodiment disclosed, decision block 222 is implemented by switching elements Q1, Q5, current limiter transistor Q200 and resistors R98, R100, R93, R921. If either of the conditions of decisions blocks 220, 222 exists, then battery 19 is disconnected from bulk capacitor 16, as shown in state block 230. Otherwise, battery 19 is connected to bulk capacitor 16 for charging, as shown in state block 232.

In summary, a downhole tool, drilling system, and a method and arrangement for charging a bulk capacitor have been described. Embodiments of the downhole tool may generally have a housing, a bulk capacitor disposed in the housing and arranged for energy storage, an electrical generator disposed in the housing and fluidly coupled to a supply of pressurized fluid for prime moving the generator, and a single-ended primary-inductance converter disposed in the housing and selectively coupled between the bulk capacitor and the generator so as to transfer electric charge from the generator to the bulk capacitor when the voltage across the bulk capacitor is between a lower set point and a higher set point. Embodiments of the drilling system may generally have a drill string, a drill bit carried by the drill string, a mud pulse telemetry device carried by the drill string, an electrical generator coupled to the telemetry device and fluidly coupled to a supply of pressurized fluid for prime moving the generator, and a single-ended primary-inductance converter coupled to the telemetry device and the generator for powering the telemetry device. Embodiments of the method for charging a bulk capacitor may generally include providing in the downhole tool a bulk capacitor that is electrically coupled to an actuator for powering the actuator, providing in the downhole tool an electrical generator, coupling a single-ended primary-inductance converter between the bulk capacitor and the generator so as to transfer charge from the generator to the bulk capacitor, charging the bulk capacitor by the generator via the converter, and at least partially discharging the bulk capacitor through the actuator to power the actuator. Finally, embodiments of the apparatus for charging a bulk capacitor may generally include a bulk capacitor arranged for energy storage, an electrical generator, a single-ended primary-inductance converter selectively coupled between the bulk capacitor and the generator so as to transfer electric charge from the generator to the bulk capacitor when the voltage across the bulk capacitor is between a lower set point and a higher set point, and a battery selectively coupled across the bulk capacitor so as to transfer electric charge from the battery to the bulk capacitor when a battery-enabling switching element is in a first state and to disconnect the battery from the capacitor when the battery-enabling switching element is in a second state.

Any of the foregoing embodiments may include any one of the following elements or characteristics, alone or in combination with each other: A solenoid powered by the bulk capacitor; a battery selectively coupled across the bulk capacitor so as to transfer electric charge from the battery to the bulk capacitor when a battery-enabling switching element is in a first state and to disconnect the battery from the bulk capacitor when the battery-enabling switching element is in a second state; a battery-disabling circuit coupled between the converter and the battery-enabling switching element and arranged to place the battery-enabling switching element in the second state when the converter is transferring electric charge from the generator to the bulk capacitor; a current limiter coupled between the battery and the bulk capacitor and arranged to limit electric current flow between the battery and the bulk capacitor; the converter defines a two port network with first and second input terminals and first and second output terminals, the second input terminal being electrically connected to the second output terminal, the generator is electrically connected to the first and second input terminals, and the bulk capacitor is electrically connected to the first and second output terminals, the converter includes first and second inductors and a first capacitor, each being characterized by first and second terminals, the converter includes a diode defining an anode and a cathode, the first terminal of the first inductor is electrically connected to the first input terminal, the first terminal of the first capacitor is electrically connected to the second terminal of the first inductor, the anode of the diode is electrically connected to the second terminal of the first capacitor, the cathode of the diode is electrically connected to the first output terminal, and the second terminal of the second inductor is electrically connected to the second input terminal, and the converter includes a control switching element operatively coupled between the first terminal of the first capacitor and the second input terminal; the first and second inductors are wound about a common core; an oscillator operatively coupled to the control switching element so as to cycle the control switching element and thereby transfer charge from the generator to the bulk capacitor; a converter-enabling circuit operatively coupled between the bulk capacitor and the oscillator and arranged to prevent cycling of the control switching element when the voltage across the bulk capacitor exceeds the higher set point and to allow cycling of the control switching element when the voltage across the bulk capacitor drops below the lower set point; the converter-enabling circuit includes a comparator that senses a potential that is proportional to the voltage across the bulk capacitor, and a positive feedback path for providing hysteresis; a converter-disabling circuit operatively coupled to the oscillator and arranged to prevent cycling of the control switching element when the bulk capacitor is discharging; a telemetry device that includes a solenoid-operated valve for producing a pressure pulse in the supply of pressurized fluid; enabling the converter when a voltage across the bulk capacitor drops below a lower set point so that the generator charges the bulk capacitor; disabling the converter when the voltage across the bulk capacitor exceeds a higher set point so that the generator does not charge the bulk capacitor; providing a battery in the downhole tool; selectively coupling the battery by a battery-enabling switching element across the bulk capacitor; enabling the battery-enabling switching element so as to transfer electric charge from the battery to the bulk capacitor; disabling the battery-enabling switching element so as to disconnect the battery from the bulk capacitor when the converter is transferring electric charge from the generator to the bulk capacitor; disabling the converter when the bulk capacitor is discharging through the actuator;

actuating the valve; fluidly coupling the valve to a source of fluid; and creating pressure pulses in the source of fluid by actuating the valve.

The Abstract of the disclosure is solely for providing the United States Patent and Trademark Office and the public at large with a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the disclosure.

What is claimed:

1. A downhole tool, comprising:
a housing;
a bulk capacitor disposed in said housing and arranged for energy storage;
an electrical generator disposed in said housing and fluidly coupled to a supply of fluid for powering said generator; and
a single-ended primary-inductance converter disposed in said housing and selectively coupled between said bulk capacitor and said generator so as to transfer electric charge from said generator to said bulk capacitor when the voltage across said bulk capacitor is between a lower set point and a higher set point.

2. The downhole tool of claim 1, further comprising:
an actuator powered by said bulk capacitor.

3. The downhole tool of claim 1, further comprising:
a battery selectively coupled across said bulk capacitor by a battery control circuit to transfer electric charge from said battery to said bulk capacitor and to isolate said battery from said bulk capacitor when said converter is transferring electric charge from said generator to said bulk capacitor.

4. The downhole tool of claim 3, wherein:
said battery control circuit includes a current limiter coupled between said battery and said bulk capacitor and arranged to limit electric current flow between said battery and said bulk capacitor.

5. The downhole tool of claim 1, wherein:
said converter defines a two port network with first and second input terminals and first and second output terminals, said second input terminal being electrically connected to said second output terminal;
said generator is electrically connected to said first and second input terminals, and said bulk capacitor is electrically connected to said first and second output terminals;
said converter includes first and second inductors and a first capacitor, each being characterized by first and second terminals;
said converter includes a diode defining an anode and a cathode;
said first terminal of said first inductor is electrically connected to said first input terminal, said first terminal of said first capacitor is electrically connected to said second terminal of said first inductor, said anode of said diode is electrically connected to said second terminal of said first capacitor, said cathode of said diode is electrically connected to said first output terminal, and said second terminal of said second inductor is electrically connected to said second input terminal; and
said converter includes a control switching element operatively coupled between said first terminal of said first capacitor and said second input terminal.

6. The downhole tool of claim 5, wherein:
said first and second inductors are wound about a common core.

7. The downhole tool of claim 5, further comprising:
an oscillator operatively coupled to said control switching element to cycle said control switching element.

8. The downhole tool of claim 5, further comprising:
a converter-enabling circuit operatively coupled between said bulk capacitor and said oscillator and arranged to prevent cycling of said control switching element when the voltage across said bulk capacitor exceeds said higher set point and to allow cycling of said control switching element when the voltage across said bulk capacitor drops below said lower set point.

9. The downhole tool of claim 8, wherein:
said converter-enabling circuit includes a comparator that senses a potential that is proportional to the voltage across said bulk capacitor, and a positive feedback path for providing hysteresis.

10. The downhole tool of claim 7, further comprising:
a converter-disabling circuit operatively coupled to said oscillator and arranged to prevent cycling of said control switching element when said bulk capacitor is discharging.

11. The downhole tool of claim 2, wherein:
said downhole tool includes a telemetry device that includes a solenoid-operated valve for producing a pressure pulse in said supply of fluid.

12. A drilling system, comprising:
a drill string;
a supply of fluid flowing through said drill string;
a drill bit carried by said drill string;
a mud pulse telemetry device carried by said drill string;
an electrical generator carried by said drill string and fluidly coupled to said supply of fluid for powering said generator; and
a single-ended primary-inductance converter coupled to said telemetry device and said generator for powering said telemetry device.

13. The drilling system of claim 12 further comprising:
a battery electrically coupled to said telemetry device by a battery control circuit for selectively powering said telemetry device.

14. The drilling system of claim 12 wherein:
said telemetry device includes a valve actuated by a solenoid;
the drilling system further comprises a bulk capacitor electrically coupled to said solenoid for powering said solenoid; and
said converter is electrically coupled to said bulk capacitor for charging said bulk capacitor.

15. The drilling system of claim 12, wherein:
said converter defines a two port network with first and second input terminals and first and second output terminals, said second input terminal being electrically connected to said second output terminal;
said generator is electrically connected to said first and second input terminals, and said bulk capacitor is electrically connected to said first and second output terminals;
said converter includes first and second inductors and a first capacitor, each being characterized by first and second terminals;
said converter includes a diode defining an anode and a cathode;
said first terminal of said first inductor is electrically connected to said first input terminal, said first terminal of said first capacitor is electrically connected to said second terminal of said first inductor, said anode of said diode is electrically connected to said second terminal of said first capacitor, said cathode of said diode is electrically connected to said first output terminal, and said second terminal of said second inductor is electrically connected to said second input terminal; and
said converter includes a control switching element operatively coupled between said first terminal of said first capacitor and said second input terminal.

16. The drilling system of claim 15, wherein:
said first and second inductors are wound about a common core.

17. The drilling system of claim 15, further comprising:
an oscillator operatively coupled to said control switching element to cycle said control switching element.

18. The drilling system of claim 15, further comprising:
a converter-enabling circuit operatively coupled between said bulk capacitor and said oscillator and arranged to prevent cycling of said control switching element when the voltage across said bulk capacitor exceeds said higher set point and to allow cycling of said control switching element when the voltage across said bulk capacitor drops below said lower set point.

19. The drilling system of claim 18, wherein:
said converter-enabling circuit includes a comparator that senses a potential that is proportional to the voltage across said bulk capacitor, and a positive feedback path for providing hysteresis.

20. The drilling system of claim 17, further comprising:
a converter-disabling circuit operatively coupled to said oscillator and arranged to prevent cycling of said control switching element when said bulk capacitor is discharging.

21. A method for operating a downhole tool, comprising:
providing in said downhole tool a bulk capacitor that is electrically coupled to an actuator for powering said actuator;
providing in said downhole tool an electrical generator;
coupling a single-ended primary-inductance converter between said bulk capacitor and said generator so as to transfer charge from said generator to said bulk capacitor;
charging said bulk capacitor by said generator via said converter; and
at least partially discharging said bulk capacitor through said actuator to power said actuator.

22. The method of claim 21 further comprising:
enabling said converter when a voltage across said bulk capacitor drops below a lower set point so that said generator charges said bulk capacitor; and
disabling said converter when the voltage across said bulk capacitor exceeds a higher set point so that said generator does not charge said bulk capacitor.

23. The method of claim 21 further comprising:
providing a battery in said downhole tool;
selectively coupling said battery by a battery control circuit across said bulk capacitor;
transferring electric charge from said battery to said bulk capacitor; and
isolating by said battery control circuit said battery from said bulk capacitor when said converter is transferring electric charge from said generator to said bulk capacitor.

24. The method of claim 21 further comprising:
disabling said converter when said bulk capacitor is discharging through said actuator.

25. The method of claim 21 further comprising:
telemetering data by actuating said valve.

26. The method of claim 21 wherein:
said actuator is a solenoid that is operatively coupled to a valve; and
the method further comprises actuating said valve.

27. The method of claim 26 further comprising:
fluidly coupling said valve to a source of fluid;
creating pressure pulses in said source of fluid by actuating said valve.

28. An arrangement for charging a bulk capacitor, comprising:
a bulk capacitor arranged for energy storage;
an electrical generator;
a single-ended primary-inductance converter selectively coupled between said bulk capacitor and said generator so as to transfer electric charge from said generator to said bulk capacitor when the voltage across said bulk capacitor is between a lower set point and a higher set point; and
a battery selectively coupled across said bulk capacitor so as to transfer electric charge from said battery to said bulk capacitor when a battery-enabling switching element is in a first state and to disconnect said battery from said capacitor when said battery-enabling switching element is in a second state.

29. The arrangement of claim 28, further comprising:
a battery-disabling circuit coupled to said converter and arranged to place said battery-enabling switching element in said second state when said converter is transferring electric charge from said generator to said bulk capacitor; and
a current limiter coupled between said battery and said bulk capacitor and arranged to limit electric current flow between said battery and said bulk capacitor.

30. The arrangement of claim 28, wherein:
said converter defines a two port network with first and second input terminals and first and second output terminals, said second input terminal being electrically connected to said second output terminal;
said generator is electrically connected to said first and second input terminals, and said bulk capacitor is electrically connected to said first and second output terminals;
said converter includes first and second inductors and a first capacitor, each being characterized by first and second terminals;
said converter includes a diode defining an anode and a cathode;
said first terminal of said first inductor is electrically connected to said first input terminal, said first terminal of said first capacitor is electrically connected to said second terminal of said first inductor, said anode of said diode is electrically connected to said second terminal of said first capacitor, said cathode of said diode is electrically connected to said first output terminal, and said second terminal of said second inductor is electrically connected to said second input terminal; and
said converter includes a control switching element operatively coupled between said first terminal of said first capacitor and said second input terminal.

31. The arrangement of claim 30, further comprising:
an oscillator operatively coupled to said control switching element so as to cycle said control switching element;
a converter-enabling circuit operatively coupled between said bulk capacitor and said oscillator and arranged to prevent cycling of said control switching element when the voltage across said bulk capacitor exceeds said higher set point and to allow cycling of said control switching element when the voltage across said bulk capacitor drops below said lower set point. wherein said converter-enabling circuit includes a comparator that senses a potential that is proportional to the voltage across said bulk capacitor, and a positive feedback path for providing hysteresis; and
a converter-disabling circuit operatively coupled to said oscillator and arranged to prevent cycling of said control switching element when said bulk capacitor is discharging.
